(19) United States
(12) Patent Application Publication
(10) Pub. No.: US 2009/0304320 A1
(43) Pub. Date: Dec. 10, 2009

(54) RADIAL CYLINDER ROLLER BEARING

(75) Inventor: Oswald Bayer, Aidhausen (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/444,876

(22) PCT Filed: Oct. 9, 2007
(86) PCT No.: PCT/DE2007/001795

§ 371 Date: Jun. 15, 2009

(30) Foreign Application Priority Data
Oct. 10, 2006 (DE) 10 2006 048 079.1

(51) Int. Cl. F16C 19/24

(52) U.S. Cl. 384/548

(57) ABSTRACT

A radial cylinder roller bearing that has an outer ring and an inner ring, both of which have a cylindrical running surface for cylinder rollers of at least one row of cylinder rollers. Each cylinder roller is braced between a loose marginal ring associated with the inner or outer ring and a complementary edge of the same bearing ring, against the other bearing ring, in such a manner that freedom from play and/or a minimum load is achieved.

### FIELD OF THE INVENTION

The invention relates to a radial cylinder roller bearing comprising an outer ring and an inner ring, in each case with a cylindrical raceway for cylinder rollers of at least one cylinder roller row.

Such radial cylinder roller bearings are sufficiently known and are used wherever a shaft is to be rotationally mounted with respect to a housing and primarily radial forces have to be absorbed. They have an outer ring with a raceway, an inner ring with a raceway and at least one cylinder roller row located between them.

Conventionally, the outer or the inner ring has rims via which the cylinder rollers are guided.

For assembly, for example, the outer ring is connected fixedly in position to a housing, while the inner ring is arranged on a shaft to be supported rotatably. The set-up and the manner of use of such radial cylinder roller bearings are basically known.

One problem in bearings of the type in question is that slip sometimes occurs when the bearing is not subjected to a minimum load. A further problem is relatively complicated play adjustment when the bearing is to be designed or mounted with predetermined play.

Furthermore, as a result of operationally induced thermal expansion, a variation in play may sometimes occur or, insofar as no play is provided or the bearing is set under prestress, a high prestress may occur. These bearings often experience a variation in play which has to be taken into account in their design, and therefore, in the cold state, the bearing is set with a play which allows for the operating conditions.

### SUMMARY OF THE INVENTION

The problem on which the invention is based, therefore, is to specify a radial cylinder roller bearing in which, in any operating state, slip is avoided and play setting is simplified.

To solve this problem, in a radial cylinder roller bearing of the type initially mentioned, there is provision, according to the invention, whereby each cylinder roller is braced, between a loose rim ring assigned to the inner or to the outer ring and a counterrim on the same bearing ring, against the other bearing ring in each case, such that freedom from play and/or a minimum load are/is achieved.

A bracing force which generates the bracing, using the loose rim ring, and acts on the respective cylinder roller D, has in this case an axial and a radial force component, similarly to an inclined ball bearing contact force, the axial force component being absorbed by the counterrim of the same bearing ring, and the radial force component being absorbed by the other bearing ring, particularly by the cylindrical raceway of the other bearing ring.

In the bearing according to the invention, particularly advantageously an axially movable rim ring is used, which may be provided on the inner or on the outer ring, depending on where the second rim, or the counterrim, staying the rollers is.

The cylinder roller is designed with a radius or so as to be rounded, in particular, in the manner of a spherical segment, at its edge adjacent to this axially movable rim ring.

The rim ring, in turn, has a tensioning face, with which it presses, during the bracing or loading of the roller against this rounded region or against this radius, and in this case introduces the bracing force into the roller where it can be divided into the axial and the radial force components.

The tensioning face, then, is shaped, in particular, in such a way that it forms with the rounded region of the roller an inclined ball bearing contact with a pressure angle less than 45°. This results in the axial force component, axial force for short, and in the radial force component, radial force for short. The radial force component presses the respective cylinder roller onto the essentially cylindrical part of the raceway of the respective counterring, with the result that freedom from play and/or minimum loading are/is achieved.

Advantageously, the cylinder rollers also have a radius, in particular a spherical segment edge, at the end stayed against the ring rim, the counterbearing face of the ring rim likewise being designed in such a way that it bears with a pressure angle less than 45° against the spherical segment edge.

This therefore gives rise to symmetrical conditions, that is to say an inclined ball bearing contact with a pressure angle less than 45° is implemented on both edge regions. A symmetrical radial force component is thus generated, which presses the roller against the raceway of the counterring. This ensures that the roller is always sufficiently loaded, so that no cage slip or roller slip can occur.

Furthermore, the play setting is also markedly simplified since, as a result of the bracing according to the invention, contact between the rollers and the raceways is always implemented and some compensation can be achieved thereby.

Expediently, the axially movable rim ring is braced by one or more spring elements. This purpose is advantageously served by a ring-shaped mounting element which serves for mounting the radial cylinder roller bearing on a third object and on which the spring element or spring elements is/are arranged, for which purpose, preferably, a peripheral groove, in which the spring element or spring elements is/are received, is provided on the mounting element.

Such a spring element may, for example, be a peripheral cup spring, but it would also be conceivable to integrate a plurality of equidistantly positioned spring elements, for example, small helical springs, in separate receptacles, for example, small blind holes. As well as a single-row version of the bearing according to the invention, it is also conceivable for the bearing to be in a double-row version, in which case each roller row is assigned a separate axially braced rim ring, and the two roller rows are stayed against a central ring rim.

### BRIEF DESCRIPTION OF THE DRAWINGS

Further advantages, features and details of the invention are described below by means of exemplary embodiments, with reference to the figures which are schematic illustrations and in which:

FIG. 1 shows a part view of a radial cylinder roller bearing according to the invention in section;

FIG. 2 shows an enlarged illustration of the region II from FIG. 1; and

FIG. 3 shows a second embodiment according to the invention of a radial cylinder roller bearing in a part view in section.

### DETAILED DESCRIPTION OF THE DRAWINGS

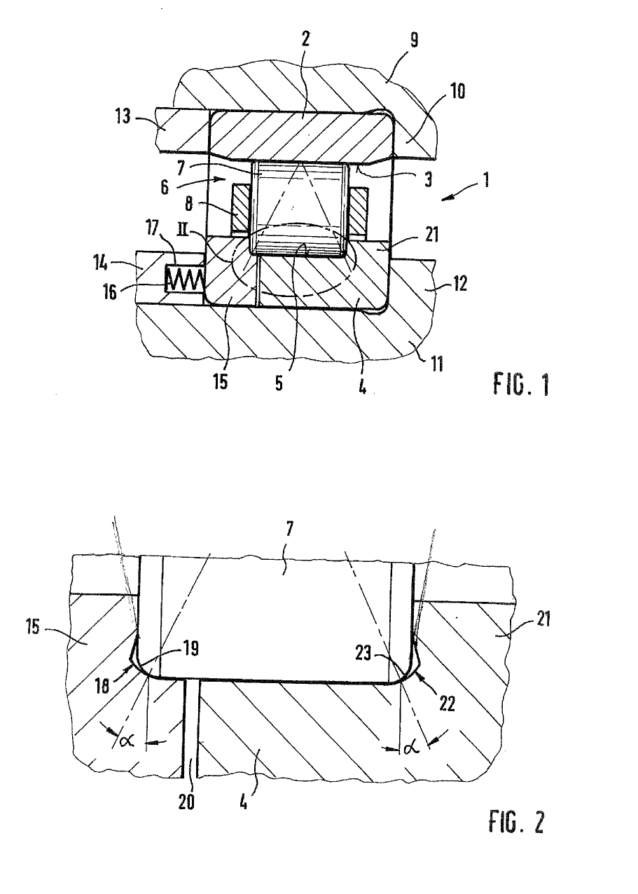

FIG. 1 shows a radial cylinder roller bearing 1 according to the invention which is shown in the mounting position. The radial cylinder roller bearing 1 consists of an outer ring 2 with a cylindrical raceway 3, of an inner ring 4 with a likewise cylindrical raceway 5 and of a cylinder roller row 6 comprising a multiplicity of separate cylinder rollers 7 which are held, spaced apart equidistantly, in a cage 8. The cylinder rollers 7 run on the raceways 3, 5. In the exemplary embodiment shown, the outer ring 2 is fastened to a housing 9 and is supported there against a stop rim 10. The inner ring 4, in turn, is arranged on a shaft 11 and there, too, is supported against a stop rim 12. To fix the individual rings, corresponding mounting elements 13, 14 in the form of suitable sleeves or the like are provided.

In the radial cylinder roller bearing 1 according to the invention, the inner ring is assigned a rim ring 15 which is axially movable. This is sprung axially in the direction of the inner ring 4 via one or more spring elements 16 arranged in a groove-shaped receptacle 17 on the mounting element 14. The rim ring 15 has a tensioning face 18, with which it engages on a spherical segment edge 19 of a cylinder roller 7. The cylinder roller has at its end, in the region of the edge, a spherical segment geometry. The tensioning face has a corresponding face portion which runs essentially obliquely and on which the contact point with the spherical segment edge lies. The tensioning face 18 of the rim ring 15, which, as shown in the enlarged view of a detail in FIG. 2, is spaced apart from the inner ring 4 via a narrow gap 20, is designed in such a way that inclined ball bearing contact between the tensioning face 18 and the spherical segment edge 19 is obtained, the pressure angle being less than 45°. The pressure angle α is depicted in FIG. 2.

As shown in FIG. 1, the cylinder roller 7 is stayed at the opposite end against a ring rim 21 of the inner ring. Correspondingly, the ring rim 21 also has a counterbearing face 22 which, with the spherical segment edge 23 which is also provided here on the cylinder roller 7, forms inclined ball bearing contact with a pressure angle α less than 45°. Here too, the counterbearing face 22 has a correspondingly obliquely running face portion which forms the inclined ball bearing contact with the spherical segment edge of the roller. This then results, overall, via these two rims, to be precise the ring rim 21 and the rim ring 15 and via the elastic prestressing mechanism via the spring element 16, in a defined loading with a defined pressure angle, resulting in a radial force component which presses the respective cylinder roller onto the essentially cylindrical part of the raceway 3 of the outer ring 2. This ensures that the respective roller is always sufficiently loaded, and cage slip or roller slip does not occur. By the spring and the radial play being appropriately coordinated, excessively high prestress can also be avoided, whereas the bearing is always free from play so that the necessary free-play guidance, for example, in the case of use in a machine tool spindle, is also ensured.

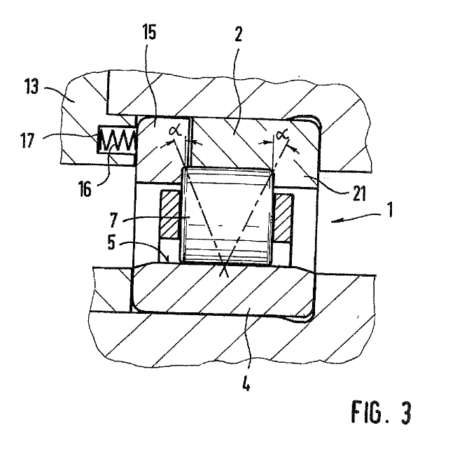

The conditions in the roller bearing 1 according to the invention, illustrated in FIG. 3, are correspondingly reversed. Here, the outer ring 2 is provided with a ring rim 21, against which the cylinder roller 7 is supported via the axially movable rim ring 15 assigned to the outer ring 2. Here, too, the rim ring 15 is again axially movable and is sprung by at least one spring element 16 which here is arranged in a corresponding receptacle 17 in the mounting element 13 which serves for fixing the outer ring 2.

As described with regard to FIGS. 1 and 2, here too, on the ring rim 15 a corresponding tensioning face is provided which cooperates with the spherical segment edge, also provided here, of the cylinder roller 7, so as to form inclined ball bearing contact with a radial force component resulting from the springing and from the pressure angle α less than 45°. There is a corresponding configuration of the counterbearing face on the ring rim 21 on the outer ring, which cooperates with the spherical segment edge on the cylinder roller in the same way as described with regard to FIGS. 1 and 2. This results overall, here too, in a symmetrical radial force component which in this configuration presses the respective cylinder roller 7 against the raceway 5 of the inner ring 4.

### REFERENCE NUMERALS

1 Radial cylinder roller bearing
2 Outer ring
3 Raceway
4 Inner ring
5 Raceway
6 Cylinder roller row
7 Cylinder roller
8 Cage
9 Housing
10 Stop rim
11 Shaft
12 Stop rim
13 Mounting element
14 Mounting element
15 Rim ring
16 Spring elements
17 Receptacle
18 Tensioning face
19 Spherical segment edge
20 Gap
21 Ring rim
22 Counterbearing face
23 Spherical segment edge

1. A radial cylinder roller bearing, comprising:
an outer ring and an inner ring, in each case with a cylindrical raceway for cylinder rollers of at least one cylinder roller row, wherein
each cylinder roller is braced between a loose rim ring assigned to the inner ring or to the outer ring and a counterrim on the same bearing ring, against the other bearing ring in each case,
bracing being generated by a bracing force which causes the bracing, using the loose rim ring, and acts on the respective cylinder roller,
the bracing force has an axial and a radial force component, the axial force component being absorbed by the counterrim of the same bearing ring, and the radial force component being absorbed by the other bearing ring.

2. The radial cylinder roller bearing as claimed in claim 1, wherein an axially movable rim ring is used, which is provided on the inner ring or on the outer ring, depending on where a second rim, or the counterrim, staying the cylinder rollers is.

3. The radial cylinder roller bearing as claimed in claim 1, wherein the cylinder rollers are, in each ease, designed with a radius or are rounded in a manner of a spherical segment, at their edge adjacent to a movable rim ring, in particular to an axially movable rim ring.

4. The radial cylinder roller bearing as claimed in claim 1, wherein the rim ring has a tensioning face, with which it the rim ring presses, during bracing of the cylinder roller, against this, in particular against a rounded region or against a radius of the cylinder roller, and in this case introduces the bracing force into the cylinder roller.

5. The radial cylinder roller bearing as claimed in claim 4, wherein the tensioning face forms with the rounded region of the cylinder roller an inclined ball bearing contact with a pressure angle less than 45°.

6. The radial cylinder roller bearing as claimed in claim 1, wherein the cylinder rollers have a spherical segment edge at an end stayed against the ring rim, and counterbearing face of the ring rim which bears with a pressure angle less than 45° against the spherical segment edge.

7. The radial cylinder roller bearing as claimed in claim 1, wherein the rim ring is braced by one or more spring elements.

8. The radial cylinder roller bearing as claimed in claim 1, wherein a ring-shaped mounting element which serves for mounting the radial cylinder roller bearing on a third object and on which spring element or spring elements is/are arranged is provided.

9. The radial cylinder roller bearing as claimed in claim 8, wherein a peripheral groove, in which the spring element or spring elements is/are received, is provided on the mounting element.

10. The radial cylinder roller bearing as claimed in claim 1, wherein two cylinder roller rows are provided which are braced via a separate rim ring.
